(19) United States
(12) Patent Application Publication
(10) Pub. No.: US 2015/0162625 A1
(43) Pub. Date: Jun. 11, 2015

(54) MULTI-RESPONSIVE FUEL CELL SYSTEM

(71) Applicant: Elwha LLC, Bellevue, WA (US)

(72) Inventors: Jesse R. Cheatham, III, Seattle, WA (US); Hon Wah Chin, Palo Alto, CA (US); Howard L. Davidson, San Carlos, CA (US); Roderick A. Hyde, Redmond, WA (US); Muriel Y. Ishikawa, Livermore, CA (US); Edward K.Y. Jung, Las Vegas, NV (US); Jordin T. Kare, Seattle, WA (US); Craig J. Mundie, Seattle, WA (US); Nathan P. Myhrvold, Bellevue, WA (US); Tony S. Pan, Cambridge, MA (US); Robert C. Petroski, Seattle, WA (US); Clarence T. Tegreene, Mercer Island, WA (US); Charles Whitmer, North Bend, WA (US); Lowell L. Wood,, Jr., Bellevue, WA (US); Victoria Y.H. Wood, Livermore, CA (US)

(21) Appl. No.: 14/098,224

(22) Filed: Dec. 5, 2013

(51) Int. Cl. H01M 8/04

(52) U.S. Cl. CPC H01M 8/0494; H01M 8/04619; H01M 8/04753

(57) ABSTRACT

An electrical power generation system includes a first fuel cell having a first responsiveness, a second fuel cell having a second responsiveness different from the first responsiveness, and a controller coupled to the first fuel cell and the second fuel cell. The controller is configured to engage the first fuel cell to satisfy at least a portion of a base load and selectively engage the second fuel cell to satisfy at least a portion of a load increase.

### BACKGROUND

Fuel cells use chemical reactions to convert chemical energy from a fuel into electricity. Fuel cells have various operating parameters. Such operating parameters include, among others, the temperature at which the fuel cell produces electricity, the amount of electricity produced by the fuel cell, and the voltage of the electricity produced by the fuel cell. Fuel cells include an anode, a cathode, and an electrolyte, which interact with the fuel and an oxidizing agent to generate electricity. By way of example, the fuel may be hydrogen, a hydrocarbon, or an alcohol. At the anode, positively charged ions and negatively charged electrons are produced and flow through the electrolyte and the electrical circuit, respectively. This flow of electrons produces electrical power that may be used to satisfy an electrical load.

### SUMMARY

One embodiment relates to an electrical power generation system that includes a first fuel cell having a first responsiveness, a second fuel cell having a second responsiveness different from the first responsiveness, and a controller coupled to the first fuel cell and the second fuel cell. The controller is configured to engage the first fuel cell to satisfy at least a portion of a base load and selectively engage the second fuel cell to satisfy at least a portion of a load increase.

Another embodiment relates to an electrical power generation system that includes a first fuel cell including a first supply value and having a first responsiveness, a second fuel cell including a second supply valve and having a second responsiveness different from the first responsiveness, and a controller coupled to the first fuel cell and the second fuel cell. The controller is configured to provide a first command signal to the first supply valve to satisfy a base load and provide a second command signal to the second supply valve to satisfy a load increase.

Another embodiment relates to an electrical power generation system that includes a first set of fuel cells including a plurality of fuel cell stacks and having a first responsiveness, a second set of fuel cells including a plurality of fuel cell stacks and having a second responsiveness different from the first responsiveness, and a controller. The controller is configured to selectively engage fuel cell stacks from at least one of the first set of fuel cells and the second set of fuel cells to satisfy a required power demand.

Still another embodiment relates to a method of generating electrical power that includes providing a first fuel cell having a first responsiveness, providing a second fuel cell having a second responsiveness different from the first responsiveness, and activating the first fuel cell to satisfy at least a portion of a base load and the second fuel cell to satisfy at least a portion of a load increase.

Yet another embodiment relates to a method of generating electrical power that includes providing a first set of fuel cells including a plurality of fuel cell stacks and having a first responsiveness, providing a second set of fuel cells including a plurality of fuel cell stacks and having a second responsiveness different from the first responsiveness, and selectively engaging fuel cell stacks from at least one of the first set of fuel cells and the second set of fuel cells to satisfy a required power demand.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic representation of an electrical power generation system, according to one embodiment;

FIG. 2 is a graphical representation of an electrical load having a power requirement that varies as a function of time;

FIGS. 3-4 are schematic representations of electrical power generation systems, according to various embodiments;

FIG. 5 is a schematic representation of an electrical power generation system that includes a first fuel cell and a second fuel cell each having an anode, a cathode, and an electrolyte, according to one embodiment;

FIG. 6 is a schematic representation of an electrical power generation system that includes a first fuel cell and a second fuel cell having separate fuel and oxidant supplies, according to one embodiment;

FIG. 7 is a schematic representation of an electrical power generation system that includes a first fuel cell and a second fuel cell having a common fuel supply, according to one embodiment;

FIG. 8 is a schematic representation of an electrical power generation system that includes a first fuel cell and a second fuel cell having a common oxidant supply, according to one embodiment;

FIG. 9 is a schematic representation of an electrical power generation system that includes a first fuel cell, a second fuel cell, and a load sensor, according to one embodiment;

FIG. 10 is a schematic representation of an electrical power generation system that includes a first fuel cell, a second fuel cell, and a processing circuit that includes a memory, according to one embodiment;

FIG. 11 is a schematic representation of an electrical power generation system that includes a first set of fuel cells and a second set of fuel cells, according to one embodiment; and

FIG. 12 is a schematic representation of a method for generating electrical power, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

According to one embodiment, an electrical power generation system includes a first fuel cell, a second fuel cell, and a controller. The first fuel cell may have a first responsiveness (e.g., a thermal-time responsiveness, a lower surface area, a different catalyst, etc.), and the second fuel cell may have a second responsiveness different from the first responsiveness. The controller may be coupled to the first fuel cell and the second fuel cell. In one embodiment, the controller engages the first fuel cell to satisfy at least a portion of a base load and selectively engages the second fuel cell to satisfy at least a portion of a load fluctuation (e.g., a load increase). The controller may engage the second fuel cell based on signals from load sensors or based on a predicted load fluctuation (e.g., a profile of loading as a function of time, etc.), according to various embodiments. In another embodiment, the first fuel cell operates independently to satisfy at least a portion of the base load, and the controller engages the second fuel cell to satisfy at least a portion of the load fluctuation.

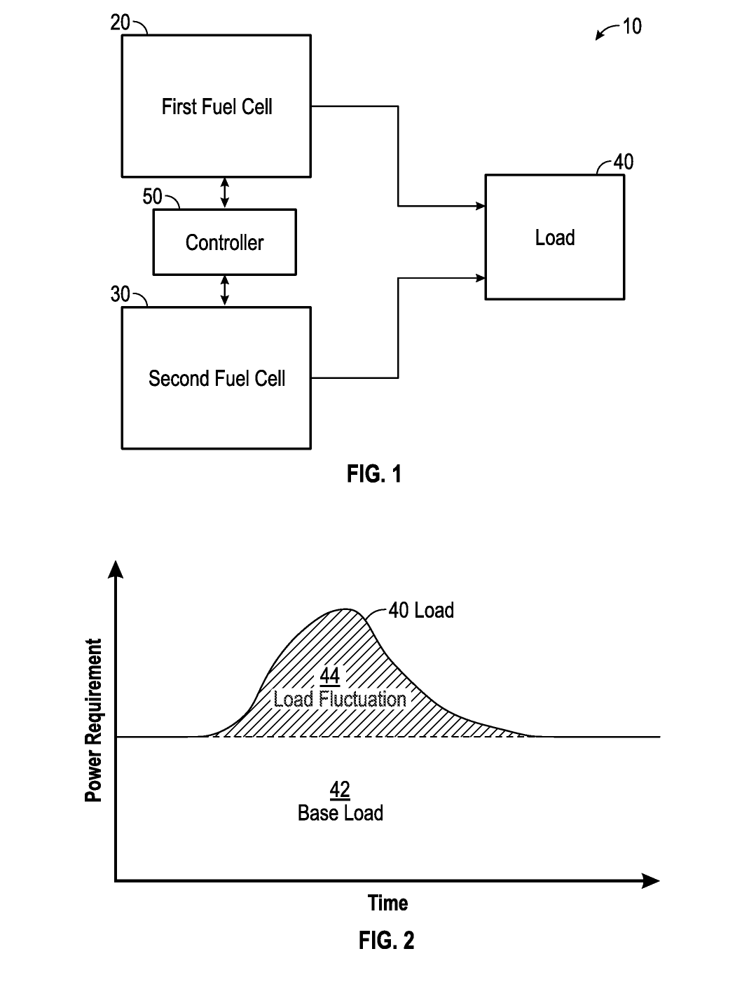

According to the embodiment shown in FIG. 1, electrical power generation system 10 includes first fuel cell 20 and second fuel cell 30. As shown in FIG. 1, first fuel cell 20 and second fuel cell 30 provide electricity to at least partially power electrical load 40. In other embodiments, thermal energy from at least one of first fuel cell 20 and second fuel cell 30 is utilized to generate electricity, heat a working fluid, or perform still another function. Controller 50 may be coupled to second fuel cell 30. As shown in FIG. 1, controller 50 is coupled to first fuel cell 20 and second fuel cell 30. In one embodiment, controller 50 is configured to engage or disengage at least one of first fuel cell 20 and second fuel cell 30. In another embodiment, controller 50 is configured to vary the power output of at least one of first fuel cell 20 and second fuel cell 30. Controller 50 may be implemented as a general-purpose processor, an application specific integrated circuit (ASIC), one or more field programmable gate arrays (FPGAs), a digital-signal-processor (DSP), a group of processing components, or other suitable electronic processing components.

In one embodiment, electrical power generation system 10 provides localized power. By way of example, electrical power generation system 10 may be used to power a vehicle (e.g., an automobile, a boat, a train, etc.) or a building (e.g., a residence, a hospital, etc.). In another embodiment, electrical power generation system 10 provides power to a power grid (e.g., a group of buildings, as part of an interconnected network for delivering electrical power to consumers, etc.). In still another embodiment, electrical power generation system 10 provides backup power (e.g., in case of power failure).

Electrical load 40 may include the electrical power demands from electrical devices, buildings, or still other systems. Electrical devices may require a constant power demand, a power demand that varies, or a power demand that is generally constant with some variability. By way of example, an electric motor for a vehicle may have a power demand that varies as a function of the required torque. A building or a power grid may require a constant power demand, a power demand that varies, or a power demand that is generally constant with some variability. By way of example, the electrical power demand for a building may remain generally constant during certain periods of time (e.g., during overnight hours when standby lights are powered and HVAC systems operate according to a preset schedule) and variable during other periods of time (e.g., during evening hours when appliance use increases). The electrical power demand for a building may also remain generally constant across a longer time scale (e.g., months, years, etc.) but vary as a function of various factors (e.g., the ambient temperature, etc.).

Referring next to FIG. 2, electrical load 40 has a power requirement that varies as a function of time. As shown in FIG. 2, electrical load 40 includes base load 42 and load fluctuation 44. In one embodiment, load fluctuation 44 is positive such that electrical load 40 has a power demand greater than base load 42 (e.g., a load increase). In another embodiment, load fluctuation 44 may be positive such that electrical load 40 has a power demand greater than base load 42 or negative such that electrical load 40 has a power demand smaller than base load 42. Base load 42 may vary within a range that is smaller than a range within which load fluctuation 44 varies, according to one embodiment. By way of example, base load 42 may remain constant (e.g., at a selected value, at a value that corresponds with power demands of electrical devices, etc.) while load fluctuation 44 may vary.

Electrical load 40 may vary based on the power demands of electrical devices. By way of example, the increased use of appliances (e.g., air conditioners) during particular periods (e.g., during periods of increased ambient temperature) may cause load fluctuation 44 to be positive. In one embodiment, base load 42 is a minimum expected value of electrical load 40. In other embodiments, base load 42 varies from the minimum expected value of electrical load 40 by an anticipated overshoot.

By way of example, electrical load 40 for a residential home may vary between 0.5 and 10 kilowatts (e.g., the minimum and maximum electrical demand for the home throughout a day or other measured period of time). Base load 42 may be selected as 1.5 kilowatts for a home having a particular electrical load profile (e.g., a measurement of electrical demand over a period of time). In one embodiment, base load 42 is selected to be above the minimum electrical demand for the home by an anticipated overshoot. By way of example, base load 42 may be selected as 1.5 kilowatts for a home having a minimum electrical demand of 0.5 kilowatts. During periods of reduced electrical use, load fluctuation 44 may be negative, and excess electricity may be used to power other devices or stored for later use. Such use or storage reduces the risk of providing a power surge to electrical load 40. At peak loading, load fluctuation 44 may be 5.5 kilowatts for a base load of 1.5 kilowatts and an electrical load 40 of 7.0 kilowatts. In another embodiment, base load 42 is selected to be the minimum electrical demand for the home (e.g., 0.5 kilowatts). At peak loading, load fluctuation 44 may be 6.5 kilowatts for a base load of 0.5 kilowatts and an electrical load 40 of 7.0 kilowatts.

By way of another example, electrical load 40 for a city may be 1,800 megawatts. For a base load 42 of 1400 megawatts, load fluctuation 44 may be 400 megawatts. It should be understood that electrical load 40 for the city may fall below 1,400 megawatts, according to one embodiment where base load 42 is selected to be above a minimum expected value for electrical load 40 by an anticipated overshoot (e.g., 100 megawatts). Excess energy may be exported (e.g., to neighboring cities) or stored (e.g., chemically in batteries, etc.) during periods where electrical load 40 is below base load 42. In other embodiments, base load 42 is selected to be the minimum expected load value.

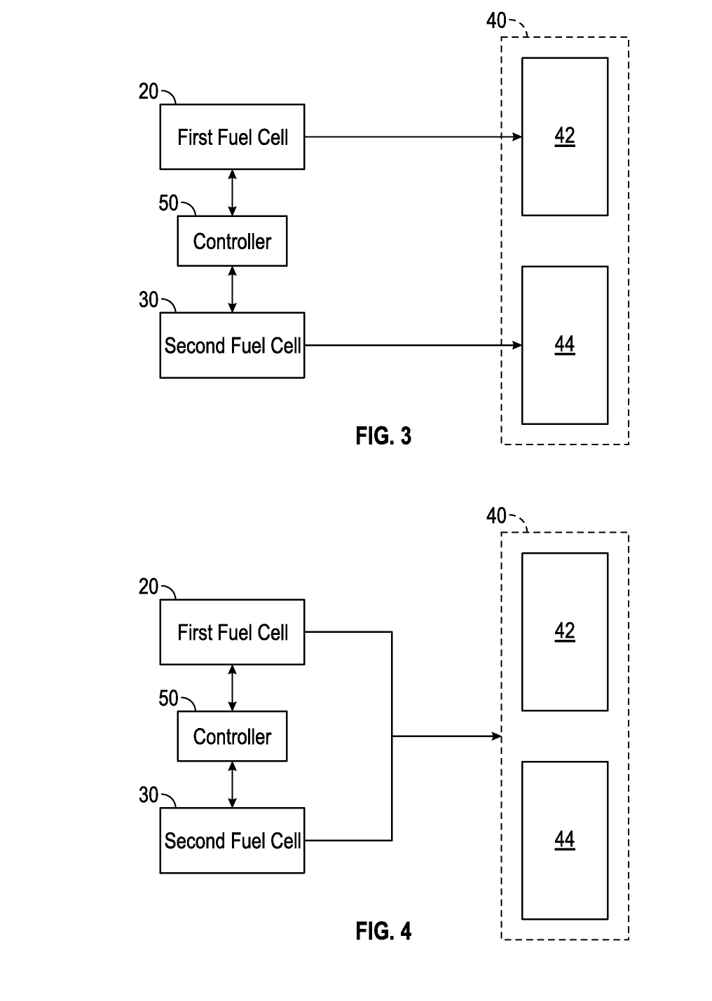

According to the embodiments shown in FIGS. 3-4, first fuel cell 20 satisfies at least a portion of base load 42, and second fuel cell 30 satisfies at least a portion of load fluctuation 44. By way of example, first fuel cell 20 may satisfy a portion of base load 42, and an additional electrical generation system (e.g., another generator, another fuel cell, etc.) may satisfy another portion of base load 42. In one embodiment, first fuel cell 20 produces a first portion (e.g., sixty percent) of base load 42 and the additional electrical generation system produces an additional portion (e.g., forty percent) of base load 42. First fuel cell 20 and the additional electrical generation system may produce the entirety of base load 42. In other embodiments, still other electrical generation systems contribute to the production of electricity to satisfy base load 42. The additional electrical generation system may be a coal-fired power plant, a nuclear power plant, or still another device. In other embodiments, the additional generation system is a combustion-powered generator (e.g., a gasoline- or diesel-powered engine that rotates a generator, etc.). Second fuel cell 30 may satisfy a portion of load fluctuation 44, and an additional electrical generation system may satisfy another portion of load fluctuation 44. In still other embodiments, first fuel cell 20 satisfies the entire base load 42, and second fuel cell 30 satisfies the entire load fluctuation 44. As shown in FIG. 3, electrical energy from first fuel cell 20 is directly applied to satisfy at least a portion of base load 42, and electrical energy from second fuel cell 30 is directly applied to satisfy at least a portion of load fluctuation 44. According to the embodiment shown in FIG. 4, the electrical outputs of first fuel cell 20 and second fuel cell 30 are coupled and provided to electrical load 40.

According to one embodiment, controller 50 is coupled to second fuel cell 30. According to the embodiment shown in FIGS. 3-4, controller 50 is coupled to first fuel cell 20 and second fuel cell 30. In one embodiment, controller 50 is configured to engage first fuel cell 20 to satisfy at least a portion of base load 42 and configured to engage second fuel cell 30 to satisfy at least a portion of load fluctuation 44. In another embodiment, first fuel cell 20 operates independently to satisfy at least a portion of base load 42, and the controller engages second fuel cell 30 to satisfy at least a portion of load fluctuation 44.

First fuel cell 20 and second fuel cell 30 may be initially configured in a disengaged state. In a disengaged state, first fuel cell 20 and second fuel cell 30 do not provide electricity to electrical load 40, according to one embodiment. By way of example, first fuel cell 20 and second fuel cell 30 may not receive a reactant (e.g., fuel, oxygen, etc.) or may be electrically decoupled (e.g., with a switch) when in the disengaged state. In one embodiment, controller 50 is configured to engage first fuel cell 20 to satisfy at least a portion of base load 42 and engage second fuel cell 30 to satisfy at least a portion of load fluctuation 44. Such engagement may include sending a command signal to a fuel source, and oxygen source, a valve, an electrical switch, or still another device. In other embodiments, controller 50 is configured to change the output of at least one of first fuel cell 20 and second fuel cell 30.

According to one embodiment, first fuel cell 20 has a first responsiveness, and second fuel cell 30 has a second responsiveness different from the first responsiveness of first fuel cell 20. The responsiveness of the fuel cell may be a rate of change of a property of the fuel cell over a period of time. By way of example, the property of the fuel cell may be operating temperature, electrical power generation, or still another characteristic. The responsiveness of at least one of first fuel cell 20 and second fuel cell 30 may be related to a feature of the fuel cells (e.g., type, materials used for the anodes, cathodes, electrolyte, catalyst, etc.). In other embodiments, the responsiveness of at least one of first fuel cell 20 and second fuel cell 30 is related to the design of the fuel cells (e.g., the quantity of catalyst, the surface area of the anode, cathode, electrolyte, etc.).

In one embodiment, the first responsiveness is less (e.g., smaller, slower, etc.) than the second responsiveness (i.e. the responsiveness of first fuel cell 20 is less than the responsiveness of second fuel cell 30). By way of example, the first responsiveness and the second responsiveness may be a thermal-time responsiveness, a power-time responsiveness, or still another type of responsiveness. In another embodiment, first fuel cell 20 may have a first thermal inertia, and second fuel cell 30 may have a second thermal inertia. By way of example, thermal inertia may be the tendency for a fuel cell to remain at a particular operating temperature, related to the ability of a fuel cell to achieve an operating temperature (e.g., during a start-up operation), or related to the ability of a fuel cell to change operating temperatures associated with load fluctuations within a specified period of time. The first thermal inertia is greater than the second thermal inertia, according to one embodiment. The property (e.g., operating temperature, electrical power generation, etc.) of a fuel cell having a lower responsiveness may not change as rapidly as the property of a fuel cell having a higher responsiveness. In one embodiment, the electrical power output of second fuel cell 30 may be varied (e.g., by controller 50) at a rate that is greater than that of first fuel cell 20.

Electrical power generation system 10 may have an improved overall efficiency (e.g., relative to fuel cell systems that employ fuel cells having the same responsiveness). In one embodiment, electrical power generation system 10 operates fuel cells that are relatively more efficient and less responsive to satisfy base loading and operates fuel cells that are relatively less efficient and more responsive to satisfy load fluctuations, thereby improving efficiency without sacrificing the ability to satisfy changes in electrical load. First fuel cell 20 having a first responsiveness may be more efficient than second fuel cell 30 having a second responsiveness. In some embodiments, first fuel cell 20 is more efficient than second fuel cell 30 but less able to accommodate changes of electrical load 40. According to one embodiment, electrical power generation system 10 operates (e.g., with controller 50) first fuel cell 20 to satisfy the portion of electrical load 40 that has reduced variability (e.g., base load 42) and operates second fuel cell 30 to satisfy the portion of electrical load 40 that has increased variability (e.g., load fluctuation 44). According to another embodiment, electrical power generation system 10 operates first fuel cell 20 to satisfy the entirety of electrical load 40 that has reduced variability and operates second fuel cell 30 to satisfy the entirety of electrical load 40 that has increased variability. In one embodiment, operating first fuel cell 20 to satisfy at least a portion of base load 42 increases efficiency (e.g., relative to operating second fuel cell 30 to satisfy at least a portion of base load 42). Operating second fuel cell 30 to satisfy at least a portion of load fluctuation 44 may reduce the risk of failing to satisfy an electrical demand (e.g., satisfy the electrical demand within a preferred time period, satisfy the electrical demand at all, etc.).

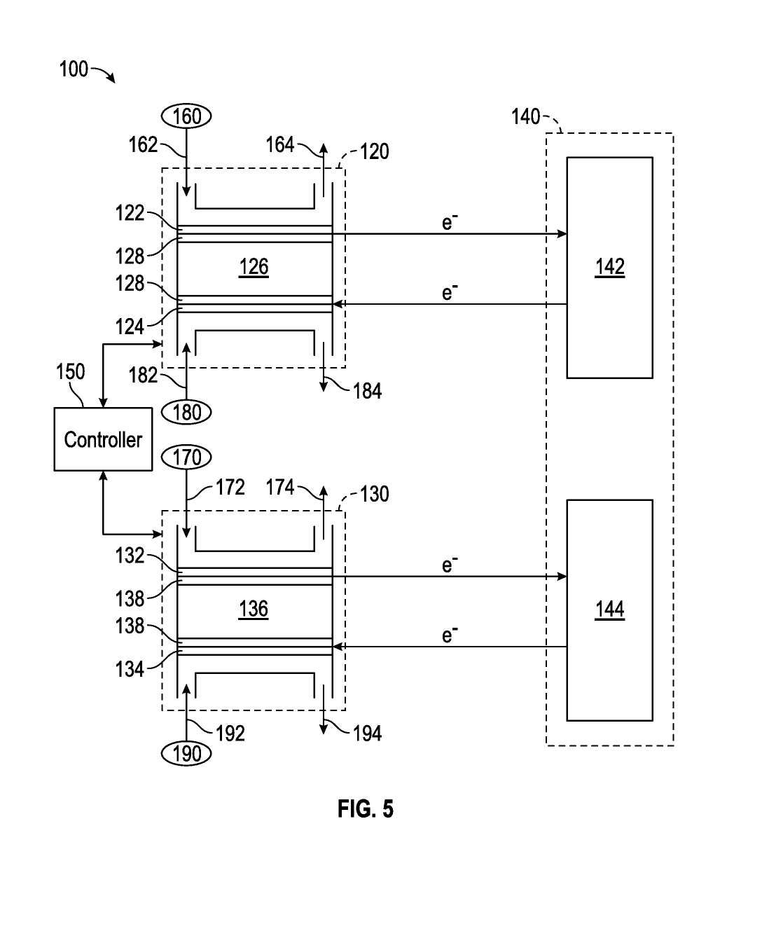

Referring next to the embodiment shown in FIG. 5, electrical power generation system 100 includes first fuel cell 120 and second fuel cell 130. As shown in FIG. 5, first fuel cell 120 and second fuel cell 130 provide electricity to at least partially satisfy electrical load 140. According to one embodiment, first fuel cell 120 has a first responsiveness, and second fuel cell 130 has a second responsiveness different from the first responsiveness of first fuel cell 120. By way of example, first fuel cell 120 may be a different type of fuel cell than second fuel cell 130. In one embodiment, first fuel cell 120 is at least one of a phosphoric acid fuel cell, a molten carbonate fuel cell, and a solid oxide fuel cell. In other embodiments, first fuel cell 120 is still another type of fuel cell (e.g., a regenerative fuel cell, a zinc air fuel cell, a microbial fuel cell, etc.). Second fuel cell 130 may be a different type of fuel cell than first fuel cell 120 (e.g., a polymer electrolyte membrane fuel cell, a direct methanol fuel cell, an alkaline fuel cell, etc.). As shown in FIG. 5, controller 150 is coupled to first fuel cell 120 and second fuel cell 130. Controller 150 is configured to engage first fuel cell 120 to satisfy at least a portion of base load 142 and to engage second fuel cell 130 to satisfy at least a portion of load fluctuation 144, according to one embodiment. Controller 150 may be implemented as a general-purpose processor, an application specific integrated circuit (ASIC), one or more field programmable gate arrays (FPGAs), a digital-signal-processor (DSP), a group of processing components, or other suitable electronic processing components.

As shown in FIG. 5, first fuel cell 120 includes anode 122, cathode 124, and electrolyte 126. Second fuel cell 130 includes anode 132, cathode 134, and electrolyte 136. According to the embodiment shown in FIG. 5, first fuel cell 120 and second fuel cell 130 include catalysts 128 and catalysts 138, respectively. According to one embodiment, electrolyte 126 of first fuel cell 120 is different (e.g., a different material, a different type of electrolyte, etc.) than electrolyte 136 of second fuel cell 130. By way of example, electrolyte 126 of first fuel cell 120 may be a liquid phosphoric acid ceramic in a lithium aluminum oxide matrix, a solid oxide an alkali carbonate retained in a ceramic matrix of lithium hydroxide, a solid ceramic, or still another material. In one embodiment, electrolyte 136 of second fuel cell 130 includes one of a solid polymer membrane and a potassium hydroxide solution in water. According to another embodiment, first fuel cell 120 operates at a first temperature (e.g., less than one hundred degrees Celsius), and second fuel cell 130 operates at a second temperature. In one embodiment, the first temperature is greater than the second temperature. By way of example, the first temperature may be between 100 and 250 degrees Celsius, 600 and 700 degrees Celsius, or 700 and 1000 degrees Celsius, among other alternatives, and the second temperature may be between 50 and 100 degrees Celsius, between 90 and 100 degrees Celsius, or about 80 degrees Celsius, among other alternatives.

Referring still to the embodiment shown in FIG. 5, first fuel cell 120 and second fuel cell 130 produce electricity from fuel. As shown in FIG. 5, fuel (e.g., hydrogen, a hydrocarbon, an alcohol, etc.) flows from a fuel source 160 and a fuel source 170 to first fuel cell 120 and second fuel cell 130 along a fuel flow path 162 and a fuel flow path 172, respectively. According to the embodiment shown in FIG. 5, an oxidant (e.g., oxygen, air, etc.) flows from an oxidant source 180 and an oxidant source 190 to first fuel cell 120 and second fuel cell 130 along an oxidant flow path 182 and an oxidant flow path 192, respectively.

According to the embodiment shown in FIG. 5, fuel from fuel source 160 interacts with anode 122, and the oxidant interacts with cathode 124. At anode 122, positively charged hydrogen ions and negatively charged electrons are produced. Excess fuel flows from first fuel cell 120 along a flow path 164. Only the positively charged hydrogen ions may pass through electrolyte 126 to cathode 124. The negatively charged electrons flow along an external circuit to satisfy at least a portion of base load 142, according to the embodiment shown in FIG. 5. Such a flow of negatively charged electrons produces an electrical current. In one embodiment, the current is a direct current. A DC/DC booster may be disposed between first fuel cell 120 and base load 142 to increase the voltage of the direct current. In one embodiment, an inverter is disposed between first fuel cell 120 and base load 142 to convert the electricity into an alternating current. At cathode 124, the negatively charged electrons and the positively charged hydrogen ions may combine with oxygen from the oxidant to produce water, which flows out of first fuel cell 120 along a flow path 184. Excess oxidant from oxidant source 180 also flows from first fuel cell 120 along flow path 184. Catalyst 128 may facilitate the interactions of the fuel and oxidant at anode 122 and cathode 124, respectively. In some embodiments, a different catalyst may be used with the fuel at the anode than the catalyst used with the oxidizer at the cathode.

Fuel from fuel source 170 interacts with anode 132 to produce positively charged hydrogen ions and negatively charged electrons. The negatively charged electrons flow along an external circuit to satisfy at least a portion of a load fluctuation 144 (e.g., a load increase), according to one embodiment. According to one embodiment, the positively charged hydrogen ions pass through electrolyte 136 and combine with the negatively charged electrons and oxygen from the oxidant to produce water, which flows from second fuel cell 130 along a flow path 194. Excess fuel flows from second fuel cell 130 along flow path 174, and excess oxidant flows from second fuel cell 130 along flow path 194.

At least one of first fuel cell 120 and second fuel cell 130 is designed to be more responsive, according to one embodiment. In one embodiment, anode 132 and cathode 134 of second fuel cell 130 have surface areas that are larger than the surface areas of anode 122 and cathode 124 of first fuel cell 120. Second fuel cell 130 including anode 132 and cathode 134 having larger surface areas is configured to be more responsive than first fuel cell 120, according to one embodiment. In another embodiment, catalyst 138 of second fuel cell 130 is different than catalyst 128 of first fuel cell 120. By way of example, catalyst 128 of first fuel cell 120 may be one of a carbon-supported platinum, nickel, a nickel oxide, or still another material. The material of catalyst 138 of second fuel cell 130 may increase the responsiveness of second fuel cell 130, according to one embodiment.

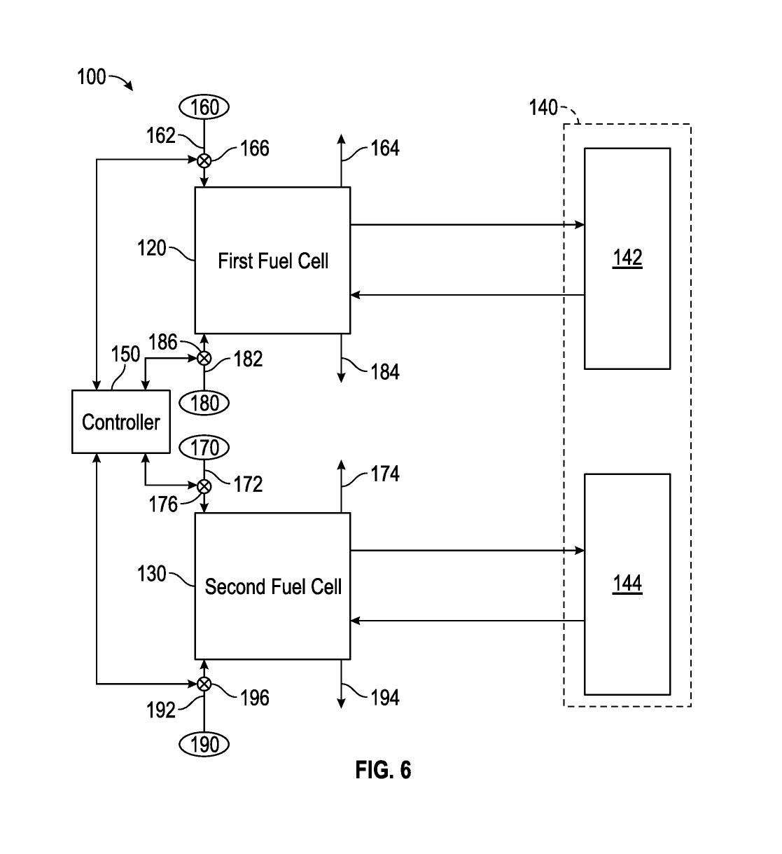

Referring next to the embodiment shown in FIG. 6, a supply valve regulates the flow of a reactant (e.g., fuel, oxidant, etc.) to first fuel cell 120 and second fuel cell 130. In other embodiments, a supply valve regulates the flow of a reactant to at least one of first fuel cell 120 and second fuel cell 130. According to one embodiment, controller 150 is configured to send a command signal to satisfy at least a portion of load fluctuation 144. According to the embodiment shown in FIG. 6, controller 150 is configured to send a first command signal to satisfy at least a portion of base load 142 and send a second command signal to satisfy at least a portion of load fluctuation 144.

In one embodiment, a supply valve is positioned along the fuel flow path of at least one of first fuel cell 120 and second fuel cell 130 and a supply valve is positioned along the oxidant flow path of at least one of first fuel cell 120 and second fuel cell 130. In another embodiment, a supply valve is positioned along the fuel flow paths of first fuel cell 120 and second fuel cell 130. In still another embodiment, a supply valve is positioned along the oxidant flow paths of first fuel cell 120 and second fuel cell 130. As shown in FIG. 6, supply valve 166 is positioned along fuel flow path 162, supply valve 176 is positioned along fuel flow path 172, supply valve 186 is positioned along oxidant flow path 182, and supply valve 196 is positioned along oxidant flow path 192.

In one embodiment, the supply valves control the flow of reactants (e.g., fuel, oxidant, etc.) into the fuel cells. As shown in FIG. 6, supply valve 166 regulates the flow of fuel to first fuel cell 120, supply valve 176 regulates the flow of fuel to second fuel cell 130, supply valve 186 regulates the flow of oxidant to first fuel cell 120, and supply valve 196 regulates the flow of oxidant to second fuel cell 130. A flow of fuel and oxidant facilitates the production of electricity by the fuel cells. By way of example, a lack of oxidant at the cathode or fuel at the anode reduces the number of chemical reactions that occur within the fuel cells. Increasing or decreasing the flow of fuel or oxidant to the fuel cell may vary the production of electricity. According to one embodiment, the supply valves are controlled to engage (e.g., from a disengaged state, increase the production of electricity from, etc.) at least one of first fuel cell 120 and second fuel cell 130 to satisfy at least a portion of an electrical load.

According to one embodiment, first fuel cell 120 has a first responsiveness, and second fuel cell 130 has a second responsiveness different from the first responsiveness of first fuel cell 120. According to one embodiment, the first responsiveness is less (e.g., smaller, slower, etc.) than the second responsiveness (i.e. the responsiveness of first fuel cell 120 is less than the responsiveness of second fuel cell 130). A supply valve for at least one of the first fuel cell 120 and the second fuel cell 130 may be configured, selected, controlled, or any combination of configured, selected, and controlled such that first fuel cell 120 is less responsive than second fuel cell 130. According to one embodiment, the supply valves for second fuel cell 130 (e.g., supply valve 176, supply valve 196, etc.) are configured to respond more quickly than the supply valves for first fuel cell 120 (e.g., supply valve 166, supply valve 186, etc.). In one embodiment, the supply valves for first fuel cell 120 may be different than the supply valves for second fuel cell 130. By way of example, the supply valves for first fuel cell 120 may be types of valves that are less responsive (e.g., less able to vary a flow rate in a specified period of time, etc.) than the supply valves for second fuel cell 130. By way of another example, the supply valves for first fuel cell 120 may be less responsive than the than the supply valves for second fuel cell 130 due to a characteristic or feature of the valve (e.g., different sizes, different solenoids, etc.). According to another embodiment, controller 150 differently engages the supply valves for first fuel cell 120 and second fuel cell 130. By way of example, controller 150 may send control signals having different profiles to the supply valves for first fuel cell 120 and second fuel cell 130 (e.g., control signals for first fuel cell 120 may lag those for second fuel cell 130, etc.). According to still another embodiment, controller 150 implements a control strategy that contributes to the responsiveness of first fuel cell 120 and second fuel cell 130. By way of example, controller 150 may delay sending control signals to the supply valves for first fuel cell 120.

According to one embodiment, controller 150 sends a command signal to satisfy at least a portion of load fluctuation 144. According to the embodiment shown in FIG. 6, controller 150 is configured to provide a first command signal to a first supply valve (e.g., supply valve 166, supply valve 186, etc.) to satisfy at least a portion of base load 142 and provide a second command signal to a second supply valve (e.g., supply valve 176, supply valve 196, etc.) to satisfy at least a portion of load fluctuation 144. The first command signal and the second command signal may be received by the first supply valve and the second supply valve. In one embodiment, the supply valves include actuators (e.g., electrical solenoids) that engage valve gates to vary a flow rate through the value. The flow rate of the reactant through the supply valve may be related to the production of electricity by the fuel cell.

According to one embodiment, the first command signal and the second command signal open the valve gates of the first supply valve and the second supply valve, respectively. The valve gates of the first supply valve and the second supply valve may be opened to satisfy at least a portion of base load 142 and load fluctuation 144, respectively. According to another embodiment, the first command signal and the second command signal change the position of the valve gates (e.g., from a first open position to a second open position, etc.) of the first supply valve and the second supply valve, respectively. The position of the valve gates of the first supply valve and the second supply valve may be changed to satisfy at least a portion of base load 142 and load fluctuation 144, respectively.

Referring still to the embodiment shown in FIG. 6, fuel source 160 and fuel source 170 are configured to separately provide fuel to first fuel cell 120 and second fuel cell 130, and oxidant source 180 and oxidant source 190 are configured to provide separate flows of oxidant to first fuel cell 120 and second fuel cell 130. In one embodiment, fuel source 160 and fuel source 170 provide the same fuel to first fuel cell 120 and second fuel cell 130. In another embodiment, fuel source 160 and fuel source 170 provide different fuels to first fuel cell 120 and second fuel cell 130 (e.g., a hydrocarbon to first fuel cell 120 and pure hydrogen to second fuel cell 130). Oxidant source 180 and oxidant source 190 may provide the same or different oxidants to first fuel cell 120 and second fuel cell 130, according to various embodiments.

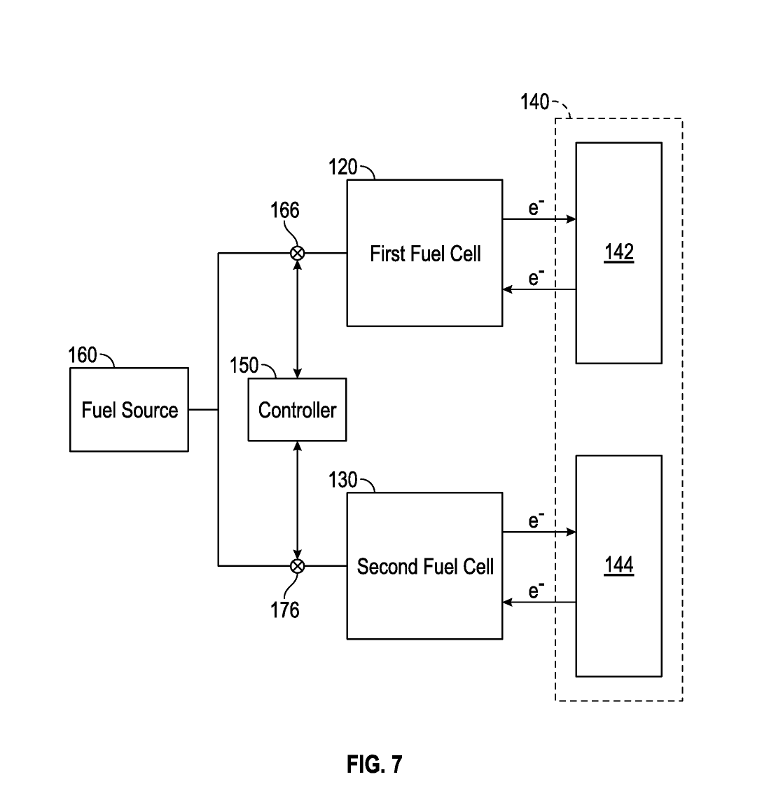

According to the embodiment shown in FIG. 7, fuel source 160 is selectively in fluid communication with both first fuel cell 120 and second fuel cell 130. As shown in FIG. 7, fuel source 160 is configured to provide the same fuel to both first fuel cell 120 and second fuel cell 130. By way of example, fuel source 160 may provide hydrogen gas to both first fuel cell 120 and second fuel cell 130. By way of another example, fuel source 160 may provide a hydrocarbon (e.g., natural gas, etc.) or an alcohol to both first fuel cell 120 and second fuel cell 130. A single or separate oxidant sources may be coupled to first fuel cell 120 and second fuel cell 130, according to various embodiments.

As shown in FIG. 7, supply valve 166 is positioned along a flow path between fuel source 160 and first fuel cell 120, and supply valve 176 is positioned along a flow path between fuel source 160 and second fuel cell 130. In one embodiment, controller 150 varies the flow of fuel to first fuel cell 120 and second fuel cell 130 by sending a first command signal to supply valve 166 and sending a second command signal to supply valve 176. Varying the flow of fuel increases or decreases the amount of electricity produced by first fuel cell 120 and second fuel cell 130. In one embodiment, supply valve 166 and supply valve 176 each include an actuator configured to engage a valve gate (e.g., open from a closed position, further open from an open position, at least partially close from an open position, etc.) in response to the first command signal and the second command signal, respectively. Controller 150 may send the first command signal to satisfy at least a portion of base load 142 and may send the second command signal to satisfy at least a portion of load fluctuation 144.

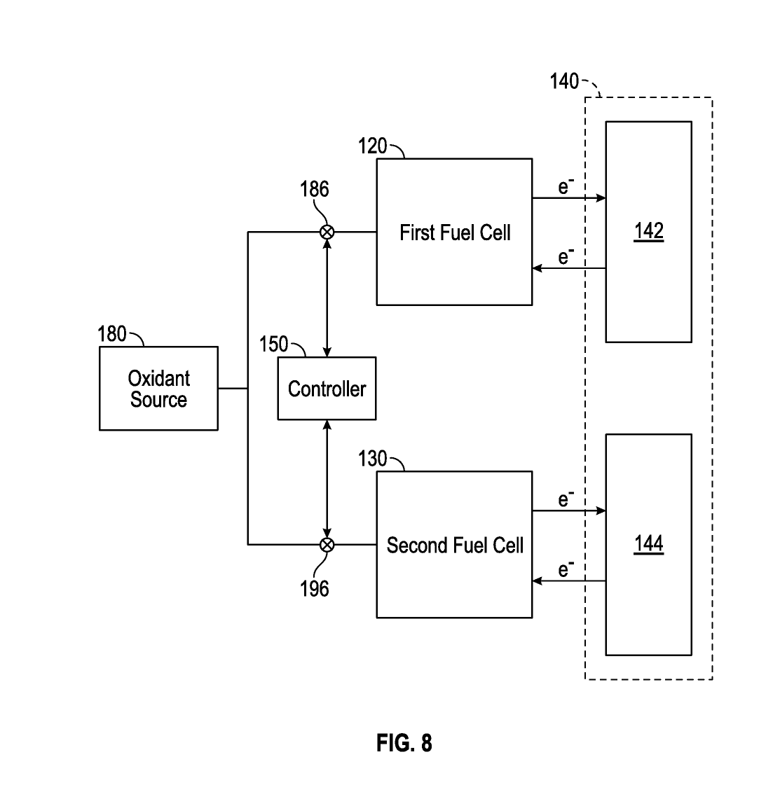

According to the embodiment shown in FIG. 8, oxidant source 180 is in fluid communication with both first fuel cell 120 and second fuel cell 130. As shown in FIG. 8, oxidant source 180 is configured to provide the same oxidant to both first fuel cell 120 and second fuel cell 130. By way of example, oxidant source 180 may provide oxygen gas to both first fuel cell 120 and second fuel cell 130. By way of another example, fuel source 160 may provide air or another oxidant to both first fuel cell 120 and second fuel cell 130. A single or separate fuel sources may be coupled to first fuel cell 120 and second fuel cell 130, according to various embodiments.

As shown in FIG. 8, supply valve 186 is positioned along a flow path between oxidant source 180 and first fuel cell 120, and supply valve 196 is positioned along a flow path between oxidant source 180 and second fuel cell 130. In one embodiment, controller 150 varies the flow of oxidant to first fuel cell 120 and second fuel cell 130 by sending a first command signal to supply valve 186 and sending a second command signal to supply valve 196. Varying the flow of oxidant increases or decreases the amount of electricity produced by first fuel cell 120 and second fuel cell 130. In one embodiment, supply valve 186 and supply valve 196 each include an actuator configured to engage a valve gate (e.g., open from a closed position, further open from an open position, at least partially close from an open position, etc.) in response to the first command signal and the second command signal, respectively. Controller 150 may send the first command signal to satisfy at least a portion of base load 142 and may send the second command signal to satisfy at least a portion of load fluctuation 144. In one embodiment, a single fuel source and a single oxidant source are coupled to first fuel cell 120 and second fuel cell 130. According to another embodiment, a single fuel source and a plurality of oxidant sources may be coupled to first fuel cell 120 and second fuel cell 130. According to still another alternative embodiment, a plurality of fuel sources and a single oxidant source may be coupled to first fuel cell 120 and second fuel cell 130.

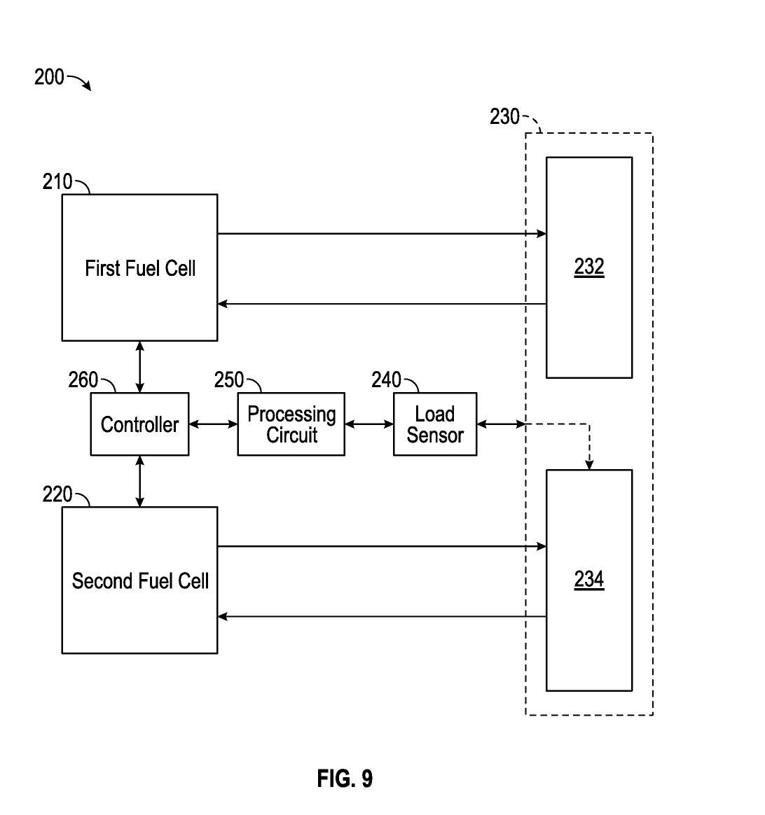

Referring next to the embodiment shown in FIG. 9, electrical power generation system 200 includes first fuel cell 210 and second fuel cell 220 that provide electricity to at least partially power electrical load 230. Electrical load 230 may include base load 232 and load fluctuation 234 (e.g., a load increase). As shown in FIG. 9, electrical power generation system 200 includes load sensor 240. Load sensor 240 facilitates the determination of a property of electrical load 230. In one embodiment, load sensor 240 facilitates the determination of a property of load fluctuation 234 of electrical load 230. As shown in FIG. 9, load sensor 240 provides a sensor signal to a processing circuit 250. Processing circuit 250 may be configured to determine a property of load fluctuation 234 based on the sensor signal. By way of example, processing circuit 250 may be configured to determine an electrical power demand of the load fluctuation or rate of change of the electrical power demand. According to one embodiment, a controller 260 is configured to satisfy at least a portion of base load 232 by engaging first fuel cell 210 and at least a portion of load fluctuation 234 by engaging second fuel cell 220. Controller 260 may be configured to engage second fuel cell 220 as the property of the load fluctuation exceeds a threshold value (e.g., as the load fluctuation exceeds two kilowatts, as the load fluctuation exceeds one hundred megawatts, as the rate of change of the load fluctuation exceeds 30 megawatts per hour, etc.). According to one embodiment, controller 260 is configured to disengage second fuel cell 220 as the property of the load fluctuation falls below a threshold value (e.g., as the rate of change of the load fluctuation falls below 3 megawatts per hour, as the load fluctuation falls below 5 megawatts, etc.). Controller 260 may be implemented as a general-purpose processor, an application specific integrated circuit (ASIC), one or more field programmable gate arrays (FPGAs), a digital-signal-processor (DSP), a group of processing components, or other suitable electronic processing components.

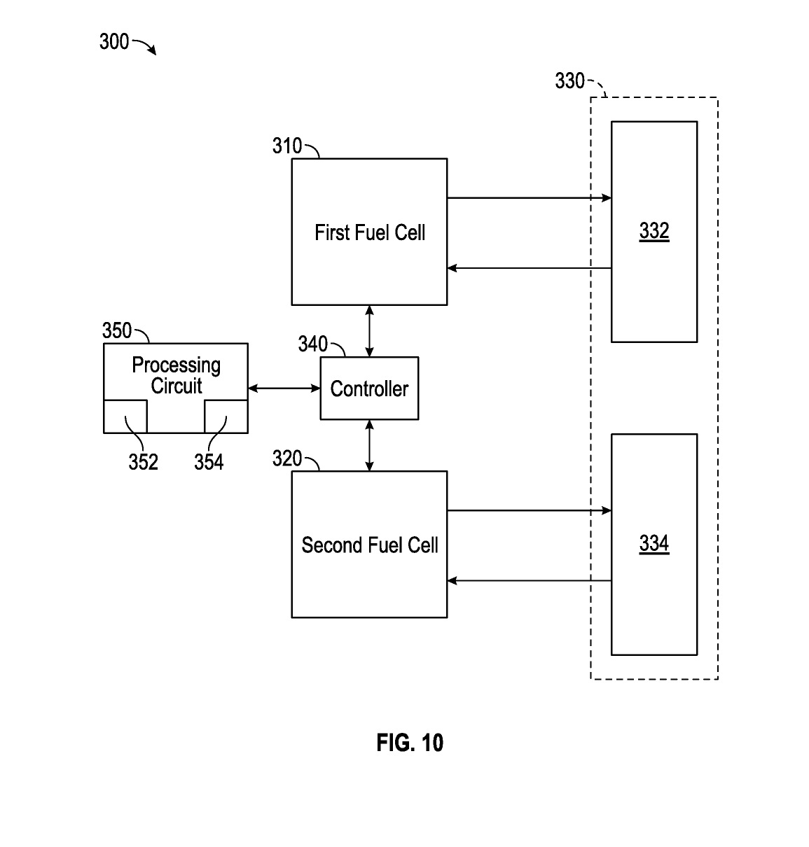

According to the embodiment shown in FIG. 10, electrical power generation system 300 includes first fuel cell 310 and second fuel cell 320 that provide electricity to at least partially power an electrical load 330. Electrical load 330 may include base load 332 and load fluctuation 334. As shown in FIG. 10, controller 340 is coupled to first fuel cell 310 and second fuel cell 320. In one embodiment, controller 340 is configured to engage first fuel cell 310 to satisfy at least a portion of base load 332 and engage second fuel cell 320 to satisfy at least a portion of load fluctuation 334. According to the embodiment shown in FIG. 10, electrical power generation system 300 includes processing circuit 350 coupled to controller 340. In one embodiment, processing circuit 350 includes memory 352 and processor 354. Memory 352 is one or more devices (e.g., RAM, ROM, Flash Memory, hard disk storage, etc.) for storing data and/or computer code for facilitating the various processes described herein. Memory 352 may be or include non-transient volatile memory or non-volatile memory. Memory 352 may include database components, object code components, script components, or any type of information structure for supporting the various activities and information structures described herein. Memory 352 may be communicably connected to processor 354 and provide computer code or instructions to processor 354 for executing the processes described herein. Processor 354 may be implemented as a general-purpose processor, an application specific integrated circuit (ASIC), one or more field programmable gate arrays (FPGAs), a digital-signal-processor (DSP), a group of processing components, or other suitable electronic processing components.

A predicted load fluctuation (e.g., a profile of the load fluctuation as a function of time, etc.) may be stored in memory 352 of processing circuit 350. In one embodiment, controller 340 is configured to selectively engage and disengage second fuel cell 320 in response to the predicted load fluctuation. According to an alternative embodiment, a predicted energy usage is stored within memory 352 of processing circuit 350. Controller 340 may be configured to selectively engage and disengage second fuel cell 320 in response to the predicted energy usage.

According to one embodiment, a first fuel cell (e.g., first fuel cell 20, first fuel cell 120, first fuel cell 210, first fuel cell 310, etc.) and a second fuel cell (e.g., second fuel cell 30, second fuel cell 130, second fuel cell 220, second fuel cell 320, etc.) each include a unit cell. According to an alternative embodiment, at least one of the first fuel cell and the second fuel cell includes a plurality of unit cells stacked together (e.g., a stack of planar-bipolar cells, a stack of tubular cells, etc.). The plurality of unit cells may be coupled (e.g., physically attached, electrically coupled, etc.) to form a cell stack.

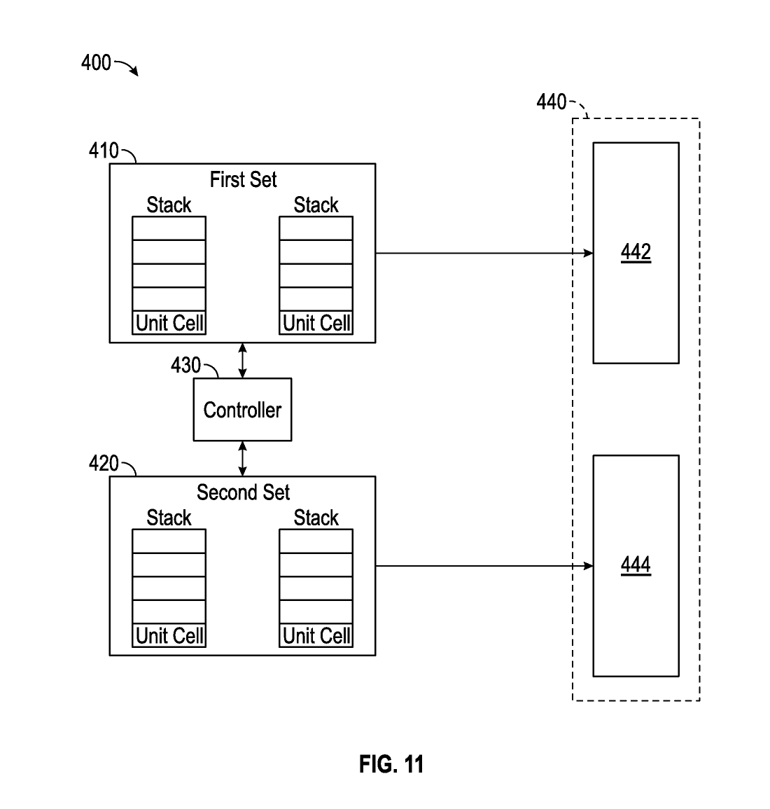

Referring next to the embodiment shown in FIG. 11, an electrical power generation system 400 includes a first set 410 of fuel cells and a second set 420 of fuel cells. First set 410 and second set 420 may each include a plurality of fuel cells stacks. In one embodiment, first set 410 has a first responsiveness, and second set 420 has a second responsiveness different from the first responsiveness. As shown in FIG. 11, electrical power generation system 400 includes a controller 430. In one embodiment, controller 430 is configured to selectively engage fuel cell stacks from at least one of first set 410 and second set 420 to satisfy a required power demand 440. Controller 430 may be implemented as a general-purpose processor, an application specific integrated circuit (ASIC), one or more field programmable gate arrays (FPGAs), a digital-signal-processor (DSP), a group of processing components, or other suitable electronic processing components. As shown in FIG. 11, required power demand 440 includes a base power demand 442 and a power fluctuation 444.

In one embodiment, at least one of the fuel cell stacks of first set 410 has a predetermined capacity (e.g., an electrical power output of one kilowatt, etc.). In another embodiment, at least one of the fuel cell stacks of second set 420 has a predetermined capacity. According to one embodiment, the predetermined capacities of fuel cell stacks of first set 410 and second set 420 are equal. According to another embodiment, the predetermined capacities of fuel cell stacks of first set 410 and second set 420 are different. By way of example, at least one of the fuel cell stacks of first set 410 may have a predetermined capacity that is greater than the predetermined capacity of at least one of the fuel cell stacks of second set 420. Controller 430 may be configured to satisfy required power demand 440 by operating fuel cell stacks from at least one of first set 410 and second set 420 at the predetermined capacity.

In another embodiment, at least one of the fuel cells stacks of first set 410 has a rated capacity range (e.g., an electrical power output range of between 0.5 and 1.5 kilowatts, etc.). The electrical power output of at least one fuel cell stack of first set 410 may be varied by changing the flow rate, composition, or other characteristic of the provided fuel or oxidant. In other embodiments, the electrical power output of at least one fuel cell stack of first set 410 is otherwise varied. At least one of the fuel cells stacks of second set 420 has a predetermined capacity or a rated capacity range, according to various embodiments. In still another embodiment, at least one of the fuel cells stacks of first set 410 has a predetermined capacity and at least one of the fuel cells stacks of second set 420 has a rated capacity range (e.g., an electrical power output range of between 0.5 and 1.5 kilowatts, etc.).

According to one embodiment, the rated capacity range of the at least one fuel cell stack of the first set 410 is narrower than the rated capacity range of the at least one fuel cell stack of the second set 420. Controller 430 may be configured to at least partially satisfy required power demand 440 by operating fuel cell stacks from at least one of first set 410 and second set 420. By way of example, controller 430 may operate first set 410 to satisfy at least a portion of base power demand 442 and second set 420 to satisfy at least a portion of power fluctuation 444.

In one embodiment, controller 430 operates at least one fuel cell stack from first set 410 at a predetermined capacity. Controller 430 may operate at least one fuel cell stack from second set 420 at a predetermined capacity or within a rated capacity range, according to various embodiments. In another embodiment, controller 430 operates at least one fuel cell stack from first set 410 within a rated capacity range. Controller 430 may operate at least one fuel cell stack from second set 420 at a predetermined capacity or within a rated capacity range, according to various embodiments.

According to one embodiment, each of the fuel cell stacks in first set 410 is configured to provide a portion of a nominal power demand (e.g., required power demand 440, etc.). Each of the fuel cell stacks in second set 420 may be configured to also provide a portion of the nominal power demand. By way of example, first set 410 may include at least four fuel cell stacks and second set 420 may include at least nine fuel cell stacks. Each of the four fuel cell stacks in first set 410 may be configured to provide power at a level of at least twenty percent of the nominal power demand, and each of the fuel cell stacks in second set 420 may be configured to provide power at a level of less than five percent of the nominal power demand. In one embodiment, controller 430 is configured to selectively engage fuel cell stacks of first set 410, fuel cell stacks of second set 420, or fuel cell stacks of first set 410 and second set 420 to provide power (e.g., electrical power, etc.) at a level of between zero and one hundred twenty five percent of the nominal power demand. The power output of at least one fuel cell stack of first set 410 and second set 420 may be variable (e.g., have a power output of between zero and five percent of the nominal power demand). By way of example, controller 430 may selectively engage one fuel cell stack (e.g., having a predetermined capacity of twenty percent of the nominal power demand) from first set 410 and two fuel cell stacks (e.g., each having a rated capacity range of between zero and five percent of the nominal power demand) from second set 420 at a level of three percent each to provide power at a level of twenty-six percent of the nominal power demand.

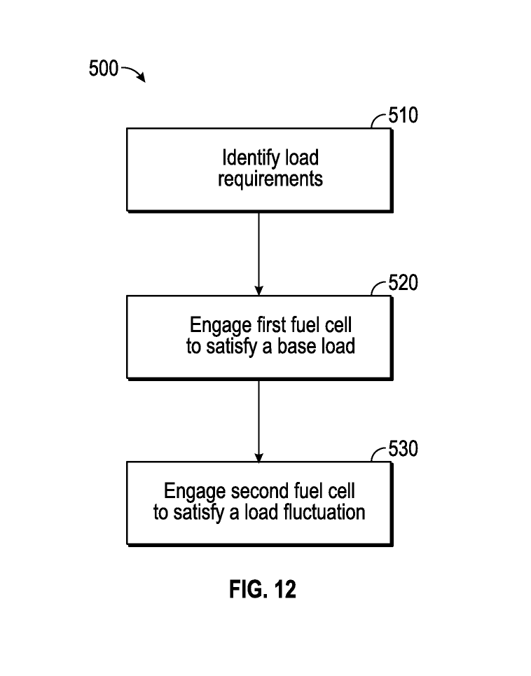

Referring to the embodiment shown in FIG. 12, method for generating electrical power 500 includes identifying load requirements (510), engaging a first fuel cell to at least partially satisfy a base load (520), and engaging a second fuel cell to at least partially satisfy a load fluctuation (530) (e.g., a load increase). In one embodiment, the first fuel cell is engaged to entirely satisfy the base load, and the second fuel cell is engaged to entirely satisfy the load fluctuation. The first fuel cell and the second fuel cell may each include a single unit cell. According to another embodiment, at least one of the first fuel cell and the second fuel cell includes a plurality of unit cells stacked together (e.g., a stack of planar-bipolar cells, a stack of tubular cells, etc.). The plurality of unit cells may be coupled (e.g., physically attached, electrically coupled, etc.) to form a cell stack. In one embodiment, the first fuel cell has a first responsiveness and the second fuel cell has a second responsiveness different than the first responsiveness. By way of example, the first responsiveness may be less than the second responsiveness.

It is important to note that the construction and arrangement of the elements of the systems and methods as shown in the embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. The order or sequence of any process or method steps may be varied or re-sequenced, according to alternative embodiments. Other substitutions, modifications, changes, and omissions may be made in the design, operating conditions, and arrangement of the preferred and other embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data, which cause a general-purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

1. An electrical power generation system, comprising:
a first fuel cell having a first responsiveness;
a second fuel cell having a second responsiveness different from the first responsiveness; and
a controller coupled to the first fuel cell and the second fuel cell, wherein the controller is configured to engage the first fuel cell to satisfy at least a portion of a base load and selectively engage the second fuel cell to satisfy at least a portion of a load increase.

2. The system of claim 1, wherein the first responsiveness is less than the second responsiveness.

3-6. (canceled)

7. The system of claim 1, wherein the first fuel cell is a different type of fuel cell than the second fuel cell.

8-18. (canceled)

19. The system of claim 1, further comprising a load sensor configured to provide a sensor signal to a processing circuit.

20. The system of claim 19, wherein the processing circuit is configured to determine a property of the load increase based on the sensor signal.

21. The system of claim 20, wherein the controller is configured to engage the second fuel cell as the property of the load increase exceeds a threshold value.

22. The system of claim 21, wherein the property of the load increase includes an electrical power demand.

23. The system of claim 21, wherein the property of the load increase includes a rate of change in electrical power demand.

24. The system of claim 20, wherein the controller is configured to disengage the second fuel cell as the property of the load increase falls below a threshold value.

25. The system of claim 24, wherein the property of the load increase includes an electrical power demand.

26. The system of claim 24, wherein the property of the load increase includes a rate of change in electrical power demand.

27-31. (canceled)

32. An electrical power generation system, comprising:
a first fuel cell including a first supply valve and having a first responsiveness;
a second fuel cell including a second supply valve and having a second responsiveness different from the first responsiveness; and
a controller coupled to the first fuel cell and the second fuel cell and configured to:
provide a first command signal to the first supply valve to satisfy at least a portion of a base load; and
provide a second command signal to the second supply valve to satisfy at least a portion of a load increase.

33. The system of claim 32, wherein the first responsiveness is less than the second responsiveness.

34-35. (canceled)

36. The system of claim 33, wherein the first fuel cell has a first thermal inertia and the second fuel cell has a second thermal inertia.

37. The system of claim 36, wherein the first thermal inertia is greater than the second thermal inertia.

38. The system of claim 32, wherein the first fuel cell is a different type of fuel cell than the second fuel cell.

39. The system of claim 38, wherein the first fuel cell is at least one of a phosphoric acid fuel cell, a molten carbonate fuel cell, and a solid oxide fuel cell.

40. The system of claim 38, wherein the second fuel cell is at least one of a polymer electrolyte membrane fuel cell, a direct methanol fuel cell, and an alkaline fuel cell.

41. The system of claim 32, further comprising a load sensor configured to provide a sensor signal to a processing circuit.

42. The system of claim 41, wherein the processing circuit is configured to determine a property of the load increase based on the sensor signal.

43. The system of claim 42, wherein the controller is configured to provide the second command signal as the property of the load increase exceeds a threshold value.

44-54. (canceled)

55. The system of claim 32, further comprising a fuel source in fluid communication with the first fuel cell and the second fuel cell.

56. The system of claim 55, wherein the first supply valve is positioned along a flow path between the fuel source and the first fuel cell.

57-58. (canceled)

59. The system of claim 55, wherein the second supply valve is positioned along a flow path between the fuel source and the second fuel cell.

60-62. (canceled)

63. The system of claim 32, further comprising a first fuel source in fluid communication with the first fuel cell and a second fuel source in fluid communication with the second fuel cell.

64. The system of claim 63, wherein the first supply valve is positioned along a flow path between the first fuel source and the first fuel cell.

65-66. (canceled)

67. The system of claim 63, wherein the second supply valve is positioned along a flow path between the second fuel source and the second fuel cell.

68-69. (canceled)

70. The system of claim 32, further comprising an oxidant source in fluid communication with the first fuel cell and the second fuel cell.

71. The system of claim 70, wherein the first supply valve is positioned along a flow path between the oxidant source and the first fuel cell.

72-73. (canceled)

74. The system of claim 70, wherein the second supply valve is positioned along a flow path between the oxidant source and the second fuel cell.

75-83. (canceled)

84. An electrical power generation system, comprising:
a first set of fuel cells including a plurality of fuel cell stacks and having a first responsiveness;
a second set of fuel cells including a plurality of fuel cell stacks and having a second responsiveness different from the first responsiveness; and
a controller configured to selectively engage fuel cell stacks of at least one of the first set of fuel cells and the second set of fuel cells to satisfy a required power demand.

85. The system of claim 84, wherein the controller is configured to satisfy the required power demand by operating the at least one fuel cell stack of the first set of fuel cells and the second set of fuel cells at a predetermined capacity.

86. The system of claim 84, wherein a rated capacity range of the at least one fuel cell stack of the first set of fuel cells is narrower than a rated capacity range of the at least one fuel cell stack of the second set of fuel cells.

87. The system of claim 86, wherein the controller is configured to satisfy the required power demand by operating fuel cell stacks of at least one of the first set of fuel cells and the second set of fuel cells within the rated capacity ranges.

88. The system of claim 84, wherein the controller is configured to satisfy the required power demand by operating the at least one fuel cell stack of the first set of fuel cells within a rated capacity range and the at least one fuel cell stack of the second set of fuel cells at a predetermined capacity.

89-167. (canceled)
